(19) United States
(12) Patent Application Publication
(10) Pub. No.: US 2009/0150352 A1
(43) Pub. Date: Jun. 11, 2009

(54) SYSTEM AND METHOD FOR INTEGRATING PRODUCT QUALITY DATA IN REMOTE PLANT DATABASES

(75) Inventors: Chi-Chih Wang, Tu-Cheng (TW); Bing-Yu He, Shenzhen City (CN); Yong-Hua Song, Shenzhen City (CN); Jie Xu, Shenzhen City (CN); Ya-Quan Li, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/195,424

(22) Filed: Aug. 21, 2008

(30) Foreign Application Priority Data
Dec. 11, 2007 (CN) 200710202982.2

(51) Int. Cl. G06F 17/30

(52) U.S. Cl. 707/3; 707/10; 707/E17.032; 707/E17.014

(57) ABSTRACT

An integration database for integrating product quality data between a plurality of plant databases is provided. The integration database includes: a material identification standardization unit configured for connecting the integration database to each of the plurality of plant databases, and for standardizing a product identification for each of the products in each of the plurality of plant databases; a plant material view creation unit configured for creating one or more plant material views for each of the plant databases in the integration database according to a corresponding product quality data for each of the plant databases; and a data integration unit configured for creating a combined summary view in the integrated database based on all the plant material views, and for collecting the product quality data of each of the plant material views into the combined summary view.

### BACKGROUND

1. Field of the Invention

Embodiments of the present disclosure relate to the field of integrating data in databases, and more particularly to a system and method for integrating product quality data in remote plant databases.

2. Description of Related Art

Various quality information systems are employed in manufacturing plants to maintain product quality. Quality information may be held or stored in different information systems located in various departments, such as production departments, sales departments, and warehouses of a manufactory. However, it is difficult for quality managers to analyze and manage the production quality information stored in the quality information systems for the different departments.

Therefore, there is a demand for a system and method for improved integration between various quality information systems so as to improve the management efficiency on the production quality information.

### SUMMARY

An integration database for integrating product quality data between a plurality of plant databases is provided. Each of the plant databases includes a database of a plurality of products and product quality data, each of the plant databases in electronic communication with a corresponding plant server, the plant servers in remote electronic communication with one another. The integration database includes: a material identification standardization unit configured for connecting the integration database to each of the plurality of plant databases, and for standardizing a product identification for each of the products in each of the plurality of plant databases, in order to identify same materials having assigned different material identification across the plurality of plant databases; a plant material view creation unit configured for creating one or more plant material views for each of the plant databases in the integration database according to a corresponding product quality data for each of the plant databases; and a data integration unit configured for creating a combined summary view in the integrated database based on all the plant material views, and for collecting the product quality data of each of the plant material views into the combined summary view.

Other advantages and novel features of the embodiments will be drawn from the following detailed description of certain inventive embodiments of the present disclosure with reference to the attached drawings, in which:

### BRIEF DESCRIPTION OF THE DRAWINGS

FIG. 1 is a schematic diagram of one embodiment of a system for integrating product quality data in remote plant databases;

FIG. 2 is a block diagram of one embodiment of the system of FIG. 1;

FIG. 3 is schematic diagram of one embodiment of creating material views for plant databases of the system of FIG. 1; and

FIG. 4 is a flowchart of one embodiment of a method for integrating product quality data in remote plant databases.

### DETAILED DESCRIPTION OF CERTAIN INVENTIVE EMBODIMENTS

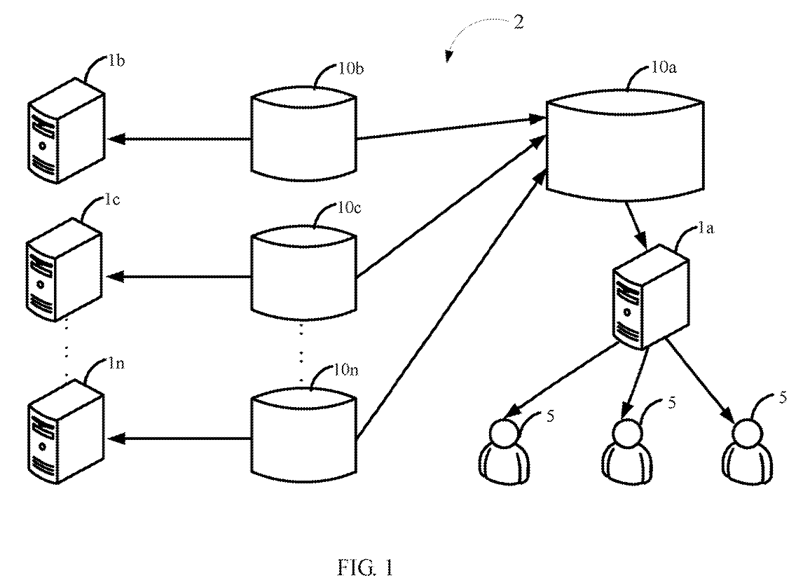

FIG. 1 is a schematic diagram of one embodiment of a system 2 for integrating product quality data in remote plant databases in accordance with the present disclosure. In one embodiment, the system 2 includes a plurality of plant databases (10a, 10b, 10c, . . . 1n) and plant servers (1a, 1b, 1c, . . . 1n). Each of the plant servers (1a, 1b, 1c, . . . 1n) and a corresponding plant database are located in different plants at different locations. The plant servers (1a, 1b, 1c . . . 1n) are remotely connected to one another. Each of the plant databases is connected to a corresponding plant server. For simplification purposes, only plant databases 10a, 10b, 10c and servers 1a, 1b, 1c will be described in the present disclosure, but it must be understood that more than one plant database and more than one plant server may be used in substantially the same process.

Each of the plant databases 10a, 10b, 10c is configured for saving various product quality data of the corresponding plant. The quality data include, but is not limited to, scrapes, impurities, overflowing glue, oil pollution, de-coloration, for example. Each of the plant servers 1a, 1b, 1c is configured for querying the product quality data of the corresponding plant in the plant database.

It may be understood that one of the plant databases 10a, 10b, 10c may be selected as an integrated database, and the other plant databases may be selected as remote databases. One of the plant databases 10a, 10b, 10c can be selected as the integrated database and a corresponding plant server can be selected as a querying server which clients 5 can query the product quality data via the corresponding plant server.

In one example and for simplification purposes, the plant database 10a is selected as the integration database, which is configured for integrating various data from the remote plant databases, the plant database 10b, 10c are selected as the remote databases. In other words, data in the plant database 10b and the plant database 10c are integrated into the plant database 10a. The plant database 10a can be queried for information about production by, for example, the clients 5, via accessing the server 1a. In another embodiment, each of the plant databases 10b, 10c can also be selected as the integration database.

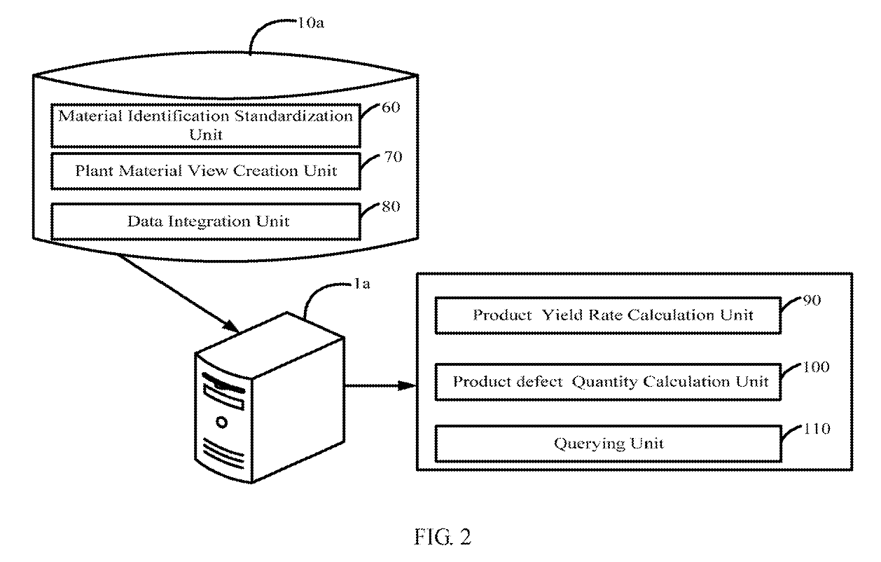

FIG. 2 is a block diagram of one embodiment of the system 2. The plant database 10a includes a material identification standardization unit 60, a plant material view creation unit 70, and a data integration unit 80.

The material identification standardization unit 60 is configured for connecting the integration database to each of the remote plant databases 10b, 10c and for standardizing material identification of all the materials in each of the remote plant databases 10b, 10c, in order to identify same materials having assigned different material identification across different plants. The material identification includes, but is not limited to, the raw material identification, the part identification, and the product identification. In the different plants, naming conventions for material identification may be different, so that, a same material may have different material identification in the different plants. For example, the product identification of a type of hard disk (HD) in the plant database 10a may be H0201012-0040001, the product identification of a same HD in the plant database 10b may be Y0201012-0040001, and in the plant database 10c may be K0201012-0040001. The material identification standardization unit 60 standardizes the product identification of HD H0201012-0040001 according to the naming convention of the plant database 10a. The clients 5 may query the product quality data in the integration database according to the material identification standardized, and arrange the product quality data in a sequence according to the plants.

The plant material view creation unit 70 is configured for allocating a storage area for each of the plant databases 10a, 10b, 10c in the integration database. Each of the storage areas is configured for storing the product quality data corresponding to each of the plant databases 10a, 10b, 10c.

The plant material view creation unit 70 is also configured for creating one or more plant material views for each of the plant databases 10a, 10b, 10c in each of the storage areas allocated in the integration database according to product quality data of each of the plant databases 10a, 10b, 10c correspondingly. Each of the plant material views corresponds to one type of product quality data such as scrapes, impurities, overflowing glue, oil pollution, de-coloration, etc. The information of each of the plant material views is updated daily according to production statuses of the materials in the different plants.

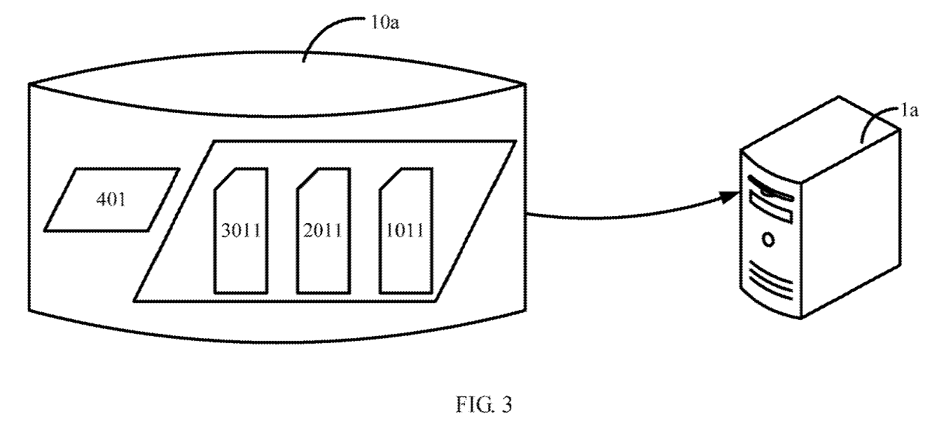

Referring to the FIG. 3, which is a schematic diagram of one embodiment of creating the plant material views for each of the plant databases 10a, 10b, 10c in each of the storage areas allocated in the integration database according to product quality data of each of the plant databases 10a, 10b, 10c correspondingly. The plant database 10a is correspondence with a plant material view 1011; the plant database 10b is correspondence with a plant material view 2011; and the plant database 10c is correspondence with a plant material view 3011. Data stored in each of the plant databases 10a, 10b, 10c are integrated into the corresponding plant material view in the integration database.

The data integration unit 80 is configured for creating a combined summary view 401 based on all the plant material views and for collecting the product quality data of each of the plant material views 1011, 2011, 3011 into the combined summary view 401. The summary view 401 is a common view. The information of the summary view 401 is synchronously updated with each of the plant material views. The summary view 401 can be queried to acquire the product quality data of each of the plant material views.

The plant server 1a includes a product yield rate calculation unit 90, a product defect quantity calculation unit 100, and a querying unit 110. The product yield rate calculation unit 90 is configured for calculating a product yield rate of each kind of product in one of the plant databases 10a, 10b, 10c, and for displaying the product yield rate of each of the products of the plant databases 10a, 10b, 10c. The product yield rate of each kind of product equals a ratio of a summary input quantity to a final product yield quantity.

The product defect quantity calculation unit 100 is configured for calculating a product defect quantity of each kind of the products in the plant, for calculating an accumulated ratio according to the summary input quantity of each kind of the products, and for displaying the product defect quantity and the accumulated ratio for the clients 5. The accumulated ratio of each kind of the products equals a ratio of the summary input quantity to the product defect quantity.

The querying unit 110 is configured for querying the summary view 401 from the integration database according to query conditions, and for generating query reports based on the queried results.

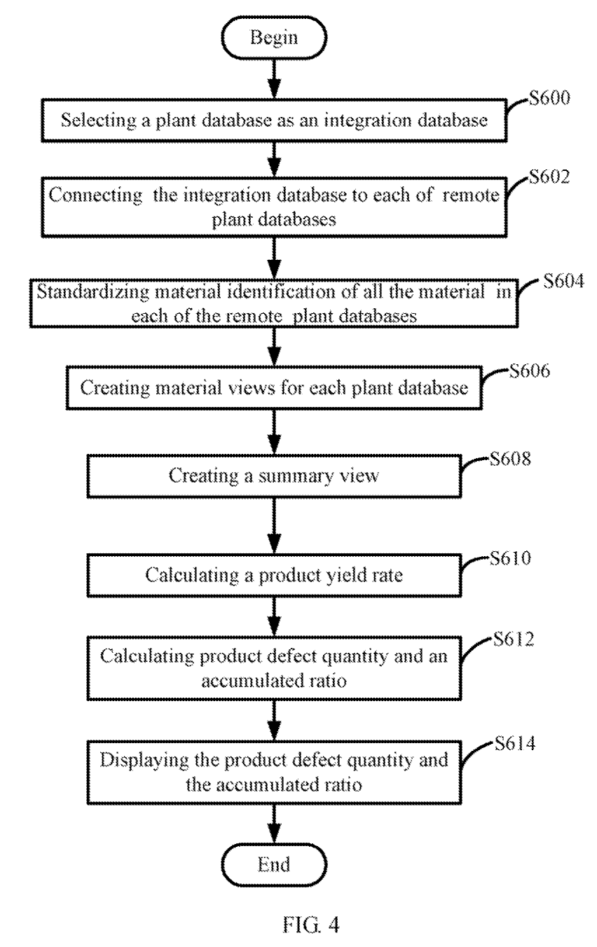

FIG. 4 is a flowchart of one embodiment of a method for integrating product quality data in remote plant databases. In block S600, one of the plant databases 10a, 10b, 10c is selected as the integration database and the other plant databases are selected as remote databases. In block S602, the material identification standardization unit 60 connects the integration database to each of the remote plant databases. In block S604, the material identification standardization unit 60 standardizes the material identification of all the materials in each of the remote plant databases, in order to identify same materials having assigned different material identification across different plants. The material identification includes, but not limited to, the raw material identification, the part identification, and the product identification.

In block S606, the plant material view creation unit 70 allocates the storage area for each of the plant databases 10a, 10b, 10c in the integration database. Each of the storage areas stores the product quality data corresponding to each of the plant databases. Then, the plant material view creation unit 70 creates one or more plant material views for each of the plant databases 10a, 10b, 10c in each of the storage areas allocated in the integration database according to product quality data of each of the plant databases 10a, 10b, 10c correspondingly. Each of the plant material views corresponds to one type of product quality data such as scrapes, impurities, overflowing glue, oil pollution, de-coloration, etc. The information of each of the plant material views is updated daily according to production statuses of the materials in the different plants.

In block S608, the data integration unit 80 collects the product quality data of each of the plant material views into the combined summary view 401. The information of the summary view 401 is synchronously updated with each of the plant material views when each of the plant material views changes. The summary view 401 can be queried to acquire the product quality data of each of the plant material views via the querying unit 110 of the server 1a, and then the querying unit 110 generates query reports based on the queried results.

In block S610, the product yield rate calculation unit 90 calculates a product yield rate of each kind of product in one of the plant databases 10a, 10b, 10c, and displays the product yield rate of each of the products of the plant databases 10a, 10b, 10c. The product yield rate of each kind of product equals a ratio of a summary input quantity to a final product yield quantity.

In block S612, the product defect quantity calculation unit 100 calculates a product defect quantity of each kind of product in the corresponding plant, calculates an accumulated ratio according to the summary input quantity of each kind of product. The accumulated ratio of each kind of product equals a ratio of the summary input quantity to the product defect quantity of each kind of product.

In block S614, the product defect quantity calculation unit 100 outputs the product defect quantity and the accumulated ratio of each kind of product, and displays the product defect quantity and the accumulated ratio of each kind of product for the clients 5.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An integration database for integrating product quality data between a plurality of plant databases, each of the plant databases comprising a database of a plurality of products and product quality data, each of the plant databases in electronic communication with a corresponding plant server, the plant servers in remote electronic communication with one another, wherein the integration database comprises:
a material identification standardization unit configured for connecting the integration database to each of the plurality of plant databases, and for standardizing a product identification for each of the products in each of the plurality of plant databases, in order to identify same materials having assigned different material identification across the plurality of plant databases;
a plant material view creation unit configured for creating one or more plant material views for each of the plant databases in the integration database according to a corresponding product quality data for each of the plant databases; and
a data integration unit configured for creating a combined summary view in the integrated database based on all the plant material views, and for collecting the product quality data of each of the plant material views into the combined summary view.

2. The integration database according to claim 1, wherein the summary view is synchronously updated with each material view.

3. The integration database according to claim 1, wherein each plant server comprises:
a product yield rate calculation unit configured for calculating a product yield rate of each kind of product from the plurality of products in a corresponding plant, and for displaying the product yield rate.

4. The integration database according to claim 1, wherein each plant server comprises:
a product defect quantity calculation unit configured for calculating product defect quantity of each kind of product from the plurality of products in a corresponding plant, and for displaying the product defect quantity.

5. A computer-implemented method for integrating product quality data in remote plant databases comprising a plurality of products, the method comprising:
selecting a plant database as an integration database;
connecting the integration database to each of remote plant databases;
standardizing material identification of all the products in each of the remote plant databases;
creating one or more plant material views for each of the plant databases in the integration database according to a corresponding product quality data of each of the plant databases;
creating a combined summary view in the integrated database based on all the plant material views and for collecting the product quality data of each plant material view into the combined summary view;
querying the combined summary view to acquire the product quality data of each of the plant material views; and
generating query reports based on the queried results.

6. The method according to claim 5, wherein each of the material views corresponds to one kind of product quality data.

7. The method according to claim 5, further comprising:
synchronously updating information of the combined summary view with each of the plant material views.

8. The method according to claim 6, further comprising:
calculating a product yield rate of each kind of the product from the plurality of products in each plant database; and
displaying the product yield rate.

9. The method according to claim 6, further comprising:
calculating product defect quantity of each kind of the product from the plurality of products in each plant database; and
displaying the product defect quantity.

10. A computer-readable medium having stored thereon instructions for integrating product quality data in remote plant databases, the computer-readable medium, when executed by a computing device, causing the computing device to perform a method comprising:
selecting a plant database as an integration database;
connecting the integration database to each of remote plant databases;
standardizing material identification of all the products in each of the remote plant databases;
creating one or more plant material views for each of the plant databases in the integration database according to a corresponding product quality data of each of the plant databases;
creating a combined summary view in the integrated database based on all the plant material views and for collecting the product quality data of each plant material view into the combined summary view;
querying the combined summary view to acquire the product quality data of each of the plant material views; and
generating query reports based on the queried results.

11. The medium according to claim 10, wherein the method further comprises:
synchronously updating information of the combined summary view with each of the plant material views.

12. The medium according to claim 10, wherein the method further comprises:
calculating a product yield rate of each kind of the product from the plurality of products in each plant database; and
displaying the product yield rate.

13. The medium according to claim 10, wherein the method further comprises:
calculating product defect quantity of each kind of the product from the plurality of products in each plant database; and
displaying the product defect quantity.
